(19) United States
(12) Patent Application Publication
(10) Pub. No.: US 2013/0264428 A1
(43) Pub. Date: Oct. 10, 2013

(54) METHOD OF SEPARABLY COUPLING A PROPULSION MODULE AND A CARRIAGE MODULE OF AN AIRCRAFT, AND MODULAR AIRCRAFT IMPLEMENTING SAME

(71) Applicant: AIRBUS OPERATIONS (S.A.S), Toulouse (FR)

(72) Inventor: François ROUYRE, Cornebarrieu (FR)

(73) Assignee: Airbus Operations (S.A.S.), Toulouse (FR)

(21) Appl. No.: 13/857,447

(22) Filed: Apr. 5, 2013

(30) Foreign Application Priority Data
Apr. 5, 2012 (FR) 12 53162

(51) Int. Cl. B64C 37/00

(52) U.S. Cl. CPC B64C 37/00
USPC 244/45 R

(57) ABSTRACT

According to one embodiment, a modular aircraft includes a propulsion module dedicated to flight, combining avionic equipment—wing structures assembly, flight deck, engines, tail unit—and a module dedicated to the carriage of passengers and/or goods. These modules include external cells extending longitudinally along a main axis and having tubular end parts of the same outline in the region of two disconnectable-coupling structures, one axial-coupling structure for keeping an end face of the propulsion module against an end face of the carriage module, and one radial-coupling structure for keeping an end face of the propulsion module against an end face of the carriage module. The wing structures assembly of the propulsion module includes two wing structures having opposite sweeps which are connected at the end and by a longitudinal connecting spar.

### TECHNICAL FIELD

The invention relates to a method of separably coupling a propulsion module dedicated to flight and a module dedicated to carriage, the coupling of these modules forming an aircraft. The invention also relates to a modular aircraft able to implement such a method.

The invention applies to the aeronautical field. Conventionally, aircraft comprise propulsion structures dedicated to flight—flight deck, engines, wings and tail unit—and structures dedicated to the carriage of passengers and/or goods—fuselage and hold. The invention relates to the connection between these structures.

### PRIOR ART

An aircraft is conventionally a single cell structured simultaneously to provide propulsion/lift and to carry passengers and/or goods.

All the operating cycles: flight, maintenance, overhaul, embarkation/loading, disembarkation/unloading, etc. have an impact on the aircraft as a whole.

The main problem is that the entire aircraft is tied up throughout all of the phases of operation of an aircraft cycle on the ground and, as a result, most of the phases are sequential and cannot be performed in parallel. Thus, the cycle remains incompressible, despite every effort made at optimizing the time spent on each of these phases.

The concept of separating the flying part and the carriage part is known. The approach was developed notably by Lockheed and described for example in pioneering patents U.S. Pat. No. 2,388,380, U.S. Pat. No. 2,577,287 or U.S. Pat. No. 2,683,005, or even in alternative forms described in patents U.S. Pat. No. 3,361,396 or U.S. Pat. No. 4,379,533. This approach involves providing an assembly between the two modules—propulsion and carriage—that makes it possible to reconstruct an overall structure similar to that of a conventional aircraft structure, with a carriage module situated under or on the module dedicated to flight.

These solutions do not allow the creation of a simple, dependable and quick disconnectable coupling between the modules. In addition, aerodynamic constraints are not met because of the discontinuities between the aerodynamic envelopes of the modules: turbulence is thus created in flight and this has the result of creating significant drag. Fuel consumption is thereby appreciably increased.

### SUMMARY

The invention seeks to get around these disadvantages by proposing two connections, an axial connection and a radial connection, between the two modules to form a central cell of continuous form. This configuration is then consistent with the aerodynamic constraints having a drag which is similar to, or even better than, that of a conventional present-day aircraft.

More specifically, one subject of the present invention is a method of separably coupling a propulsion module dedicated to flight, incorporating avionic equipment—wing structures assembly, flight deck, flight controls, drive, tail unit—and a module dedicated to the carriage of passengers and/or goods, the coupling of these modules forming a modular aircraft. This method consists in creating the modules around an external form with overall continuous curvature extending longitudinally along a main axis and having complementary tubular coupling end parts. It then consists in axially coupling the coupling ends of the modules aligned along a longitudinal axis coinciding with the main axes using disconnectable mechanical connections. A longitudinal connection is formed axially and a connection is formed radially so that continuity of external form occurs at these connections, the propulsion module being positioned behind the carriage module in the conventional direction of travel of the aircraft. The wing structure of the propulsion module comprises two opposite sweeps which are connected at the end and between the disconnectable mechanical connections.

Advantageously, the avionic equipment of the propulsion module—flight deck, flight controls, wing structure assembly, drive, tail unit—is positioned according to the requirements for balancing in order to observe the laws of mechanics of flight of the modular aircraft once it has been assembled.

This modular nature allows the use of several carriage modules for one and the same propulsion module. It is thus possible to get around the need of making the same aircraft up using the same modules each time, thus improving the flight cycle: the carriage module can be prepared in advance of the phase of use, allowing a significant time saving. In addition, the maintenance cycles involving the carriage module are also optimized because they can be performed as a parallel task, and the propulsion module operating time is optimized for reduced operating costs. In particular, the time spent parked on the ground is reduced to a minimum. In addition, the times spent pressurizing and depressurizing the carriage module can be evened out over time.

Preferably, the carriage module is disconnected as soon as the aircraft lands and is transported to a disembarkation station of the airport, thus allowing a new module to be reconnected to the same propulsion module immediately, ready for a new flight.

According to advantageous embodiments:

the distance between the wing structure sweeps is set to minimize the flow of load between the wing structure and the propulsion module; that being so, the flow of load absorbed is substantially less than the load absorbed in the current design in which the wings are embedded in the fuselage of an aircraft—by the first rib of the central section—because the lever arm, which passes on the fixed-end bending moment between the wing structure and the fuselage of a conventional aircraft, is thereby appreciably lengthened;

the carriage module has an oblong external fuselage of a shape and length that are suited to the type of carriage—passengers and/or goods—and to the type of flight—long-haul or medium-haul—the shape of the fuselage making it possible to define substantially the same center of gravity while at the same time varying the capacity to carry goods and/or passengers, the axial and radial connections making it possible to achieve an interchangeable coupling between one propulsion module and various carriage modules;

the external shape of the fuselage is dimensioned so that it too, in addition to the wing structure of the propulsion module, contributes to creating the lift of the modular aircraft and thus improving the overall balance;

the external shape of the fuselage of the carriage module is that of an ogive in order to improve drag during flight.

The invention also relates to a modular aircraft able to implement such a method. This modular aircraft comprises a propulsion module dedicated to flight, combining avionic equipment—wing structures assembly, flight deck, flight controls, engines, tail unit—and a module dedicated to the carriage of passengers and/or goods, these modules being coupled to one another by disconnectable mechanical means. The modules comprise external cells extending longitudinally along a main axis and having tubular end parts of the same outline in the region of two disconnectable-coupling means—one axial-coupling means which extends axially to keep an end face of the propulsion module against an end face of the carriage module, these complementary faces extending radially, and one radial-coupling means which extends radially to keep an end face of the propulsion module against an end face of the carriage module, these complementary faces extending longitudinally—so as to form a continuous continuation of external form at the coupling means, the propulsion module being positioned behind the carriage module in the conventional direction of travel of the aircraft. The wing structures assembly of the propulsion module comprises two wing structures having opposite sweeps which are connected at the end and by a longitudinal connecting spar extending between the disconnectable-coupling means.

According to certain preferred embodiments:

said end faces are substantially planar;

the wing structures assembly is made up of an upper wing structure, positioned forward of a lower wing structure which supports the engine and comprises two symmetric wings which are embedded in the propulsion module under the flight deck, and the upper wing structure extends above the carriage module and comprises a central portion which is extended longitudinally by the connecting spar and is embedded in a complementary portion of the carriage module, these portions having the complementary faces on which the radial-coupling means are mounted;

said complementary faces of said portions are planar, the longitudinal complementary face of the carriage module forming a flat on the carriage module;

a retractable front landing gear is mounted on the carriage module and a retractable rear landing gear is mounted on the propulsion module;

at least one additional catching element is mounted in a rear position of the carriage module and can be coupled disconnectably to a catching element mounted on a vehicle that drives the carriage module along on the ground, the catching elements forming a disconnectable-coupling means;

each of the axial-coupling means and radial-coupling means consists of at least one disconnectable element, particularly a spigot, combined with a retractable locking means arranged in a housing.

### DESCRIPTION OF THE DRAWINGS

Further details, features and advantages of the present invention will become apparent from a study of the non-limited description which follows, with reference to the attached figures which respectively depict:

FIGS. 1a and 1b: perspective overall views of two examples of a modular aircraft according to the invention comprising a module intended for the carriage of passengers and of goods respectively;

FIGS. 2a and 2b: perspective views of the passenger-carriage and goods-carriage modules corresponding to FIGS. 1a and 1b respectively;

FIG. 3: a side view of the two modules of one example of modular aircraft according to the invention, these being positioned along one and the same axis so that they can be coupled;

FIG. 3a: a view in cross section of the means of disconnectable attachment of the passenger carriage module according to FIG. 3 to a vehicle that drives it along on the ground;

FIG. 3b: a view in cross section of one example of a mounting of a spigot of the axial-coupling means of the carriage module according to FIG. 3;

FIG. 4: a half view from the front of the propulsion module according to FIG. 3; and

FIGS. 5a and 5b, a side view and a view from above of the modular aircraft of FIG. 3 after the modules have been coupled.

### DETAILED DESCRIPTION

In this text, the qualifiers “front”, “rear”, “upper” and “lower” or their equivalents, relate to elements which are positioned in relation to an aircraft in conventional movement. The qualifiers “transverse”, “longitudinal”, “radial” denote positionings in relation to the main dimension of an aircraft extending along an axis X′X.

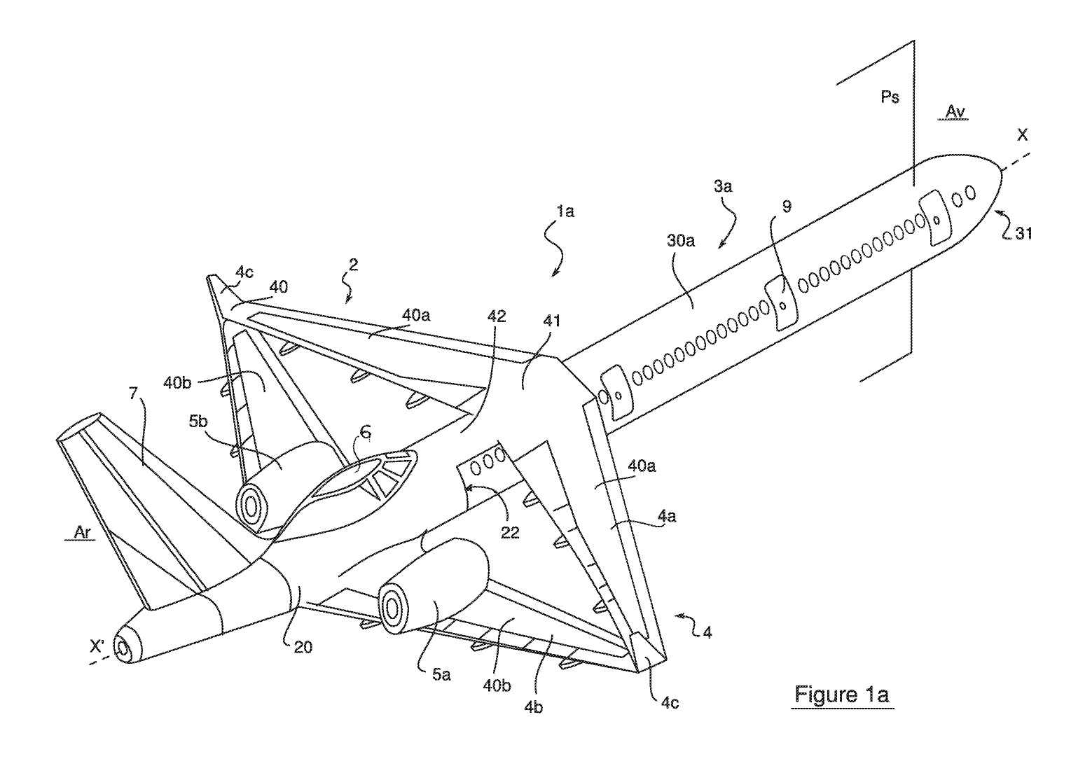

With reference to the overall views of FIGS. 1a and 1b, two examples of a modular aircraft la and lb according to the invention have been illustrated. These aircrafts have one and the same propulsion module 2 coupled to the rear of a module 3a for the carriage of passengers and their luggage (FIG. 1a) or of a module 3b for the carriage of goods (FIG. 1b), along a main axis X′X. The aircraft and its constituent modules exhibit symmetry with respect to a central plane Ps which, when the aircraft or the modules are on the ground, is vertical. The modules 2, 3a and 3b have central external forms 20, 30a, 30b of overall continuous curvature. The interchangeable nature of the modules means that the operating cycles for operating a fleet of aircraft can be optimized.

The propulsion module 2 incorporates the avionic equipment dedicated to flight and flight control around the central tubular cell 20: a double wing structure 4, engines 5a, 5b, a flight deck 6, flight controls (built into the electronic cabinets in the hold and not visible in the figures), and a steering tail unit 7 arranged at the rear of the tubular cell 20.

The double wing structure 4 is made up of an upper wing structure 4a and of a lower wing structure 4b which extend transversely to the central cell 20 and are jointed together at their ends 40. The length of the connections between the wing structures 4a, 4b is reduced because of the sweeps formed by these wing structures. The structural bracing of these sweeps stiffens the reaction to the cantilever effect between the built-in end where the lower wing structure 4b is embedded in the central cell 20 and the coupling of the top wing structure 4a to the carriage module 3a or 3b. In addition, vertical winglets 4c are provided at the tips of the wings to contribute to weakening the wing tip vortex effect and reduce the drag of the aircraft.

The upper wing structure 4a, arranged forward of the lower wing structure 4b, comprises two wings 40a which form a sweep bending toward the front “Av” of the aircraft and are connected by a central portion 41. This central portion 41 is extended longitudinally by a connecting spar 42 between the upper wing structure 4a and a radial end face 22 of the central tubular cell 20 of the propulsion module 2. This spar provides reinforcement and balances structural loading. In addition, the length of this spar is determined so that the distance between the wing structure sweeps minimizes the absorption of the flow of load between the wing structure and the propulsion module.

The lower wing structure 4b supports the engines 5a, 5b and that makes it possible to reduce the noise impact on the ground during take off or landing phases. This lower wing structure 4b is made up of two symmetric wings 40b which form a sweep bending toward the rear “Ar” of the aircraft. The length of the connections between the wing structures 4a, 4b is reduced because of the sweeps. The wings 40b of the lower wing structure 4b are embedded laterally in the central cell 20 under the flight deck 6. A calculator of a center of gravity (not depicted) assists with balancing the propulsion module by managing the mass of fuel contained in the upper wing structure 4a compared with that contained in the lower wing structure 4b.

The carriage module 3a or 3b extends longitudinally along the same axis X′X as the propulsion module 2 and to the front of this same module 2. The front 31 of the carriage modules 3a, 3b advantageously has the shape of an ogive providing aerodynamic optimization for best penetration through the air and to limit the angle of drag in flight. The module 3a is in the form of a substantially cylindrical fuselage of circular base 30a, making it possible to simplify its production line and its maintenance. Access doors 9 are incorporated into the fuselage.

Because the carriage module is not designed to obey only flight control constraints, these being dedicated to the propulsion module, there is even more freedom in the form it can adopt. However, this carriage module is self-contained in terms of energy supply as it houses an auxiliary power unit (APU). An APU in fact supplies the energy necessary for starting the engines, for the air conditioning and for pressurizing the module.

The form of the carriage module can be adapted homothetically to suit the type of goods and/or the type of flight, for example from a transversely widened form like that illustrated in FIG. 1b. This module in particular has an external fuselage of oblong shape of ovoid type 30b, of a length suited to the type of goods and to the type of flight—long-haul or medium-haul—this ovoid shape of the fuselage allowing more or less the same center of gravity to be defined while at the same time varying the capacity to carry goods or passengers.

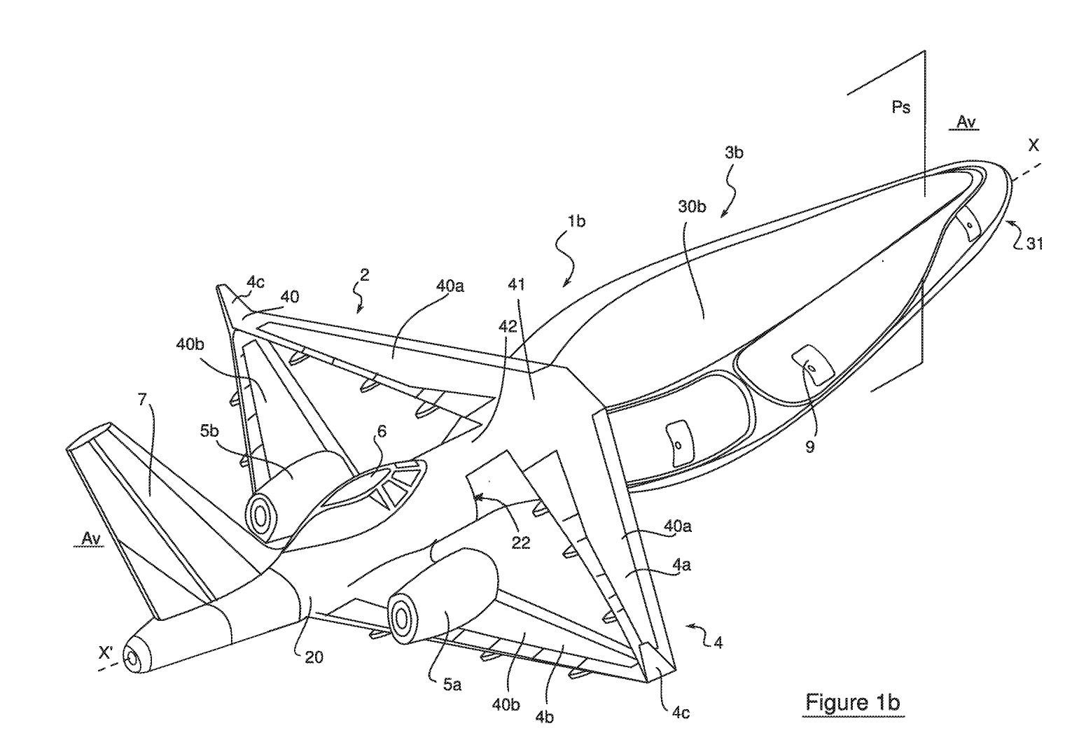

FIGS. 2a and 2b respectively show the passenger-carriage module 3a and goods-carriage module 3b. More specifically, the coupling faces 32 and 33 for coupling with the propulsion module are visible in these figures. These faces are planar and orthogonal. The face 32 is radial and extends perpendicular to the main axis X′X. The longitudinal other face 33 extends parallel to the axis X′X as far as, on the one hand, an edge 100 in common with the radial face 32 and, on the other hand, a radial cutout 101 of an upper cylindrical section 102.

Spigots 50 and 51 are respectively incorporated into the radial face 32 and longitudinal face 33 in order to perform the mechanical couplings with the propulsion module, as will be described in greater detail hereinafter. As an alternative, these spigots may be incorporated into the corresponding coupling faces of the propulsion module. These spigots are situated substantially in the central plane of symmetry Ps of the modules 3a and 3b and are off-centered respectively toward the edge 100 and toward the cutout 101 in order to maximize the push-together fit of the modules and the relative immobilization thereof once coupled. Effective and safe locking of the “fail safe” type (see below) is thus obtained.

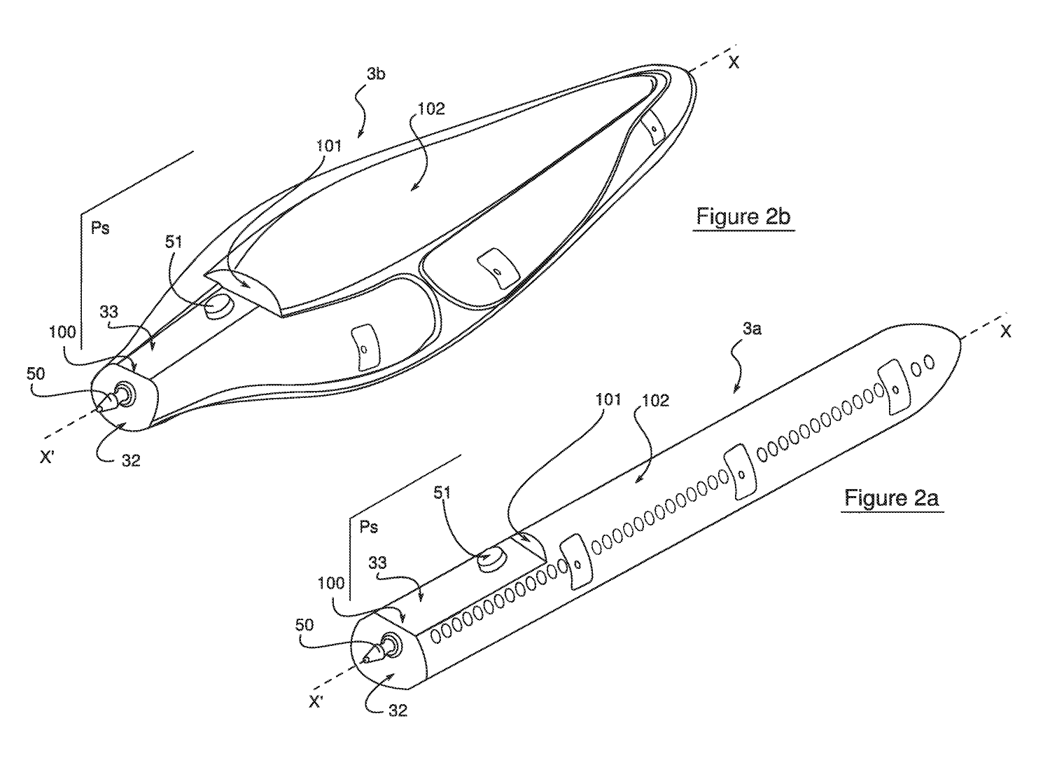

The mechanical couplings to be achieved between a carriage module 3a and a propulsion module 2 are now described with reference to the side view of FIG. 3 which illustrates these modules aligned along the axis X′X so that they can be coupled. The modules have, facing one another, tubular end parts 31a and 21 of the same outline, so as to ensure complementary shape continuity, after coupling, with the same external form.

The carriage module 3a comprises, arranged under the generally cylindrical fuselage 30a of this module: cameras 70 which assist with running, a retractable front landing gear 34, coupling spigots 50 and 51 and an additional spigot 55 for coupling to a vehicle 5 that tows it along the ground.

In one embodiment, the view in cross section of FIG. 3a illustrates the spigot for attachment of the carriage module 3a to a towing vehicle 5. This additional spigot 55 enters a housing 62 of the vehicle 5 via a bushing 52 mounted on a bearing 53.

Prior to coupling to the propulsion module, the passengers and luggage and/or the goods are loaded as a parallel operation then, as soon as the carriage module 3a is ready to depart, it can already be pressurized, making it possible to even out the cabin pressurizing/depressurizing curves, for better passenger comfort.

In addition to the equipment already described with reference to FIGS. 1a and 1b, the propulsion module 2 comprises, with reference to FIG. 3, the orthogonal coupling faces—the radial face 22 (to be coupled to the face 32) and the longitudinal face 23 (to be coupled to the face 33)—a retractable landing gear 24, a stabilizing stand leg 25—to facilitate coupling/uncoupling phases and to stabilize the module while it is being filled with fuel—and retractable locking shutters 60 and 61 (shown as hidden detail through the wing structure 4a). These locking means are mounted in housings 62, 63 which receive the spigots 50 and 51 of the carriage module 3a. In the phase in which the propulsion module 2 approaches and runs along the axis of the carriage module 3a, the pilots are assisted by cameras 71, 72 installed on the central portion 41 of the upper wing structure 4a of the module: there is no longer a direct view of the runway because the spar 42 and the upper wing structure 41 do not allow a complete view but instead allow an appreciation to be gained via viewing means capable of supplying additional data, for example regarding the condition of the runway.

The coupling (arrows Fc) of the two modules by bringing them axially closer together along the axis X′X is automated by laser with load transfer compensation—in the same way as known guidance systems of “Belouga” type—in order to avoid any risk of damage. The spigots 50 and 51 simultaneously and respectively marry with the housings 62 and 63. When the flanges 40c and 41c of the spigots 50 and 51 have penetrated sufficiently far into the housings 62 and 63, the blocking shutters 60, 61 are actuated under pressure to block the spigots and lock them in these housings. The axial housing 50 of the radial face 32 is a cylindrical recess 62. The housing of the radial spigot 51 of the longitudinal face 33 is a longitudinal slot 63 made in the central portion 41.

The coupling between the modules has built-in safety (or is what is known as “fail safe”), guaranteeing an equivalent of two points of connection to each coupling point thanks to their positioning in interfaces 22/32 and 23/33 which are orthogonal. This coupling makes it possible to prevent any risk of the modules becoming detached.

The center-of-gravity computer mentioned earlier is also used for balancing according to the type of carriage module connected to the propulsion module, and in flight to balance the aircraft to make it stable and flyable, in conjunction with the flight controls.

When the propulsion 2 and carriage 3a or 3b modules are being separated following landing, the propulsion module goes to the end of the runway and the pressure on the shutters is removed: the spigots 50 and 51 are released by the withdrawal of the shutters 60 and 61 freed of their pressurizing. A drive vehicle comes to collect the carriage module to bring the passengers or goods to the terminal provided for disembarkation. The carriage module remains self-contained in terms of energy by starting its APU. During the transfer time, a new module, which has already been filled, is coupled to the propulsion module so that the aircraft thus reconstructed can run out to the end of the runway and take off immediately.

The view in cross section in FIG. 3b shows one example of the mounting of the spigot 50 on the rear coupling face 32 of the carriage module 3a. The spigot 50 is mounted on a domed sealed end 15 held by a structural stiffening web 16. The domed end 15 is fixed at the end of the fuselage skin 30a by orbital rivets 17. A fairing 18 extends the fuselage skin to form the coupling face 32.

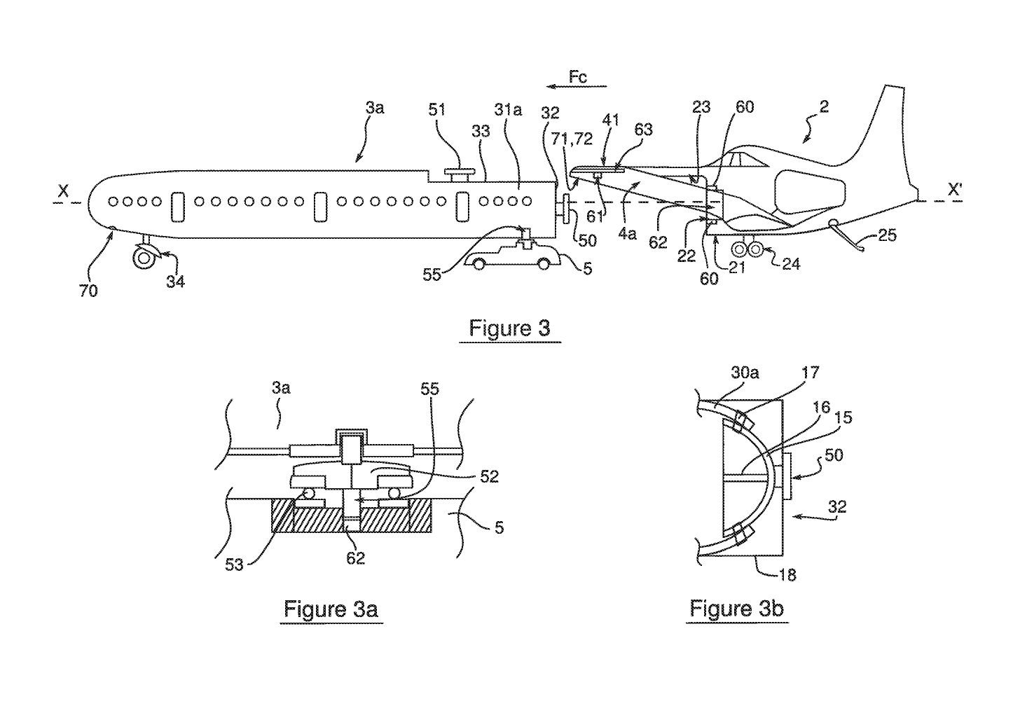

With reference to the front half view of the propulsion module 2 illustrated in FIG. 4, it is apparent that the upper wing 40a and the lower wing 40b of the wing structures are far enough apart that the upper wing 40a does not disturb the engine 5a. This figure also partially shows the coupling face 22 for coupling with the radial face 32 of the carriage module 3a (see FIG. 2a), the flight deck 6 and the tail unit 7.

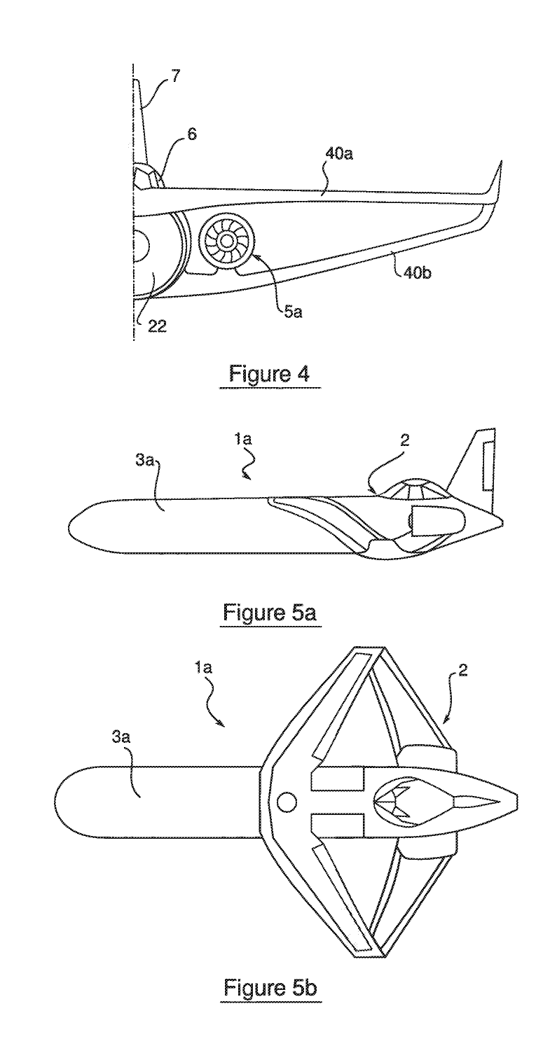

When the two, propulsion 2 and carriage 3a, modules are coupled by the blocking of the spigots 50 and 51 in the appropriate housings 62 and 63 by the shutters 60 and 61 (FIG. 3), the modular aircraft 1 is as illustrated in the side and top views of FIGS. 5a and 5b. The carriage module 3a in this instance is a module of the “ferry flight module” type created using a very short fuselage in the overall shape of an ogive and dimensioned to ballast the aircraft and give it an aerodynamic shape. The external forms of the modules 2 and 3a are in continuous continuation once the modules have been coupled which means that the aircraft la appears to be made up as a single piece. Advantageously, the forms may be slightly conical in order to improve their centering and flush fitting and the aerodynamic connection between them.

The invention is not restricted to the embodiments described and depicted. Thus, there may be multiple spigots on each coupling face, these for example being organized in a line, a circle or an array. These spigots may be mounted on the coupling faces of the carriage module or of the propulsion module. Further, the pressure means applying pressure to the spigots may be actuating cylinders, springs or elastic leaves.

1. A method of separably coupling a propulsion module dedicated to flight, incorporating avionic equipment—wing structures assembly, flight deck, flight controls, drive, tail unit—and a module dedicated to the carriage of passengers and/or goods, the coupling of these modules forming a modular aircraft, said method consisting in creating the modules around an external form with overall continuous curvature extending longitudinally along a main axis and having complementary tubular coupling end parts, then, in axially coupling the coupling ends of the modules aligned along a longitudinal axis coinciding with the main axes using disconnectable mechanical connections comprising a longitudinal connection formed axially and a connection formed radially so that continuity of external form occurs at these connections, the propulsion module being positioned behind the carriage module in the conventional direction of travel of the aircraft, wherein the wing structures assembly of the propulsion module comprises two opposite sweeps which are connected at the end and between the disconnectable mechanical connections, and wherein this wing structures assembly is made up of an upper wing structure, positioned forward of a lower wing structure which supports the engines and comprises two symmetric wings which are embedded in the propulsion module under the flight deck, and in which the upper wing structure extends above the carriage module and comprises a central portion which is extended longitudinally by the connecting spar and is embedded in a complementary portion of the carriage module, these portions having the complementary faces on which the radial-coupling means are mounted.

2. The method of coupling as claimed in claim 1, in which the external shape of the fuselage of the carriage module is dimensioned so that it too, in addition to the wing structure of the propulsion module, contributes to creating the lift of the modular aircraft.

3. The method of coupling as claimed in claim 1, in which the external shape of the fuselage is that of an ogive in order to improve drag during flight.

4. A modular aircraft comprising a propulsion module dedicated to flight, combining avionic equipment—wing structures assembly, flight deck, flight controls, engines, tail unit—and a module dedicated to the carriage of passengers and/or goods, these modules being coupled to one another by disconnectable mechanical means, these modules comprising external cells extending longitudinally along a main axis and having tubular end parts of the same outline in the region of two disconnectable-coupling means, one axial-coupling means which extends axially to keep an end face of the propulsion module against an end face of the carriage module, these complementary faces extending radially, and one radial-coupling means which extends radially to keep an end face of the propulsion module against an end face of the carriage module, these complementary faces extending longitudinally, so as to form a continuous continuation of external form at the coupling means, the propulsion module being positioned behind the carriage module in the conventional direction of travel of the aircraft, wherein the wing structures assembly of the propulsion module comprises two wing structures having opposite sweeps which are connected at the end and by a longitudinal connecting spar extending between the disconnectable-coupling means, and wherein this wing structures assembly is made up of an upper wing structure, positioned forward of a lower wing structure which supports the engines and comprises two symmetric wings which are embedded in the propulsion module under the flight deck, and in which the upper wing structure extends above the carriage module and comprises a central portion which is extended longitudinally by the connecting spar and is embedded in a complementary portion of the carriage module, these portions having the complementary faces on which the radial-coupling means are mounted.

5. The modular aircraft as claimed in claim 4, in which said end faces are substantially planar.

6. The modular aircraft as claimed in claim 4, in which said complementary faces are planar, the longitudinal complementary face of the carriage module forming a flat.

7. The modular aircraft as claimed in claim 4, in which a retractable front landing gear is mounted on the carriage module and a retractable rear landing gear is mounted on the propulsion module.

8. The modular aircraft as claimed in claim 4, in which at least one additional catching element is mounted in a rear position of the carriage module and can be coupled disconnectably to a catching element mounted on a vehicle that drives the carriage module along on the ground, the catching elements forming a disconnectable-coupling means.

9. The modular aircraft as claimed in claim 4, in which each of the axial-coupling means and radial-coupling means consists of at least one disconnectable element, particularly a spigot, combined with a retractable locking means arranged in a housing.
